(19) United States
(12) Patent Application Publication
(10) Pub. No.: US 2006/0268575 A1
(43) Pub. Date: Nov. 30, 2006

(54) Backlight control circuit

(75) Inventors: Kun Le, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/443,145

(22) Filed: May 30, 2006

(30) Foreign Application Priority Data
May 27, 2005 (TW) 94117385

(51) Int. Cl. F21V 7/04

(52) U.S. Cl. 362/611

(57) ABSTRACT

A backlight control circuit (200) includes an electrical source (240), a signal input terminal (210), a pulse width modulation integrated circuit (PWM IC) (220) having an enable pin (221), and a transistor (231). The transistor includes a drain electrode, a source electrode, and a gate electrode. The drain electrode of the transistor is connected to the signal input terminal. The source electrode of the transistor is connected to the enable pin of the PWM IC. The gate electrode of the transistor is connected to the electrical source via a first resistor (232) and connected to ground via a second resistor (233). The configuration of the backlight control circuit is simple.

### FIELD OF THE INVENTION

The present invention relates to a backlight control circuit for a liquid crystal display (LCD).

### GENERAL BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions.

A typical LCD includes an LCD panel, a backlight for illuminating the LCD panel, an inverter circuit for driving the backlight, and a backlight control circuit for driving the inverter circuit.

FIG. 2 is a circuit diagram of a typical backlight control circuit used in an LCD. The backlight control circuit 100 includes a signal input terminal 110, a capacitor 122, a pulse width modulation integrated circuit (PWM IC) 120 for driving an inverter circuit (not shown), a switch unit 130 used to control the PWM IC 120, a first resistor 132, a second resistor 133, and an electrical source (VCC). The PWM IC 120 includes an enable pin 121, which is connected to ground via the capacitor 122. The switch unit 130 includes a first transistor 131 and a second transistor 134. Each transistor 131, 134 includes a drain electrode “d”, a gate electrode “g”, and a source electrode “s”. The gate electrode “g” of the first transistor 131 is connected to the signal input terminal 110 via the second resistor 133. Both the source electrode “s” of the first transistor 131 and the gate electrode “g” of the second transistor 134 are connected to the electrical source (VCC) via the first resistor 132. Both the drain electrode “d” of the first transistor 131 and the drain electrode “d” of the second transistor 134 are connected to ground. The source electrode “s” of the second transistor 134 is connected to the enable pin 121 of the PWM IC 120. The first and second transistors 131, 132 can be negative-positive-negative (NPN) type transistors or positive-negative-positive (PNP) type transistors. The electrical potential provided by the electrical source VCC is 5V.

Generally, operation of the backlight control circuit 100 is as follows. When the LCD is turned on by a user, a scaler IC (not shown) of the LCD generates an “ON” signal (3.3V) and supplies the “ON” signal to the signal input terminal 110. When the LCD is turned off by a user, the scaler IC (not shown) of the LCD generates an “OFF” signal (0V) and supplies the “OFF” signal to the signal input terminal 110.

When the electrical potential at the signal input terminal 110 is 0V, the first transistor 131 of the switch unit 130 is turned off because the voltage V_{gd} between the gate electrode “g” of the first transistor 131 and the drain electrode “d” of the first transistor 131 is lower than 0.6V. Then the electrical source VCC causes the second transistor 314 to switch to an activated state, and the enable pin 121 of the PWM IC 120 which is connected to the source electrode “s” of the second transistor 134 is discharged to a low voltage (0V) via the drain electrode “d” of the second transistor 134. The PWM IC 120 stops working when the enable pin 121 thereof is at a low voltage. Then the inverter circuit (not shown) which is driven by the PWM IC 120 is turned off. Thus the backlight (not shown) which is driven by the inverter circuit (not shown) is shut down.

When the electrical potential at the signal input terminal 110 is 3.3V or larger, the first transistor 131 of the switch unit 130 is turned on because the voltage V_{gd} between the gate electrode “g” of the first transistor 131 and the drain electrode “d” of the first transistor 131 is higher than 0.6V. Then the gate electrode “g” of the second transistor 134 is electrically connected to ground via the drain electrode “d” of the first transistor 131. Thus the second transistor 134 is turned off, because the voltage V_{gd} between the gate electrode “g” of the second transistor 134 and the drain electrode “d” of the second transistor 134 is lower than 0.6V. Consequently, the enable pin 121 of the PWM IC 120 is charged to a high level voltage by an inner circuit (not shown) of the PWM IC 120. The PWM IC 120 starts to work when the enable pin 121 thereof is a high level voltage. Then the PWM IC 120 turns on the inverter circuit (not shown), and the inverter circuit (not shown) drives the backlight to illuminate an LCD panel of the LCD.

However, the backlight control circuit 110 has a relatively complicated configuration. It is desired to provide a backlight control circuit which overcomes this deficiency.

### SUMMARY

A backlight control circuit includes an electrical source, a signal input terminal, a pulse width modulation integrated circuit (PWM IC) having an enable pin, and a transistor. The transistor includes a drain electrode, a source electrode, and a gate electrode. The drain electrode of the transistor is connected to the signal input terminal. The source electrode of the transistor is connected to the enable pin of the PWM IC. The gate electrode of the transistor is connected to the electrical source via a first resistor and connected to ground via a second resistor.

Advantages and novel features of the above-described circuit will become more apparent from the following detailed description when taken in conjunction with the accompanying drawings, in which:

### BRIEF DESCRIPTION OF THE DRAWINGS

FIG. 1 is a circuit diagram of a backlight control circuit for use in an LCD according to a preferred embodiment of the present invention; and

FIG. 2 is a circuit diagram of a conventional backlight control circuit used in an LCD.

### DETAILED DESCRIPTION OF PREFERRED EMBODIMENTS

Reference will now be made to the relevant drawing to describe the present invention in detail.

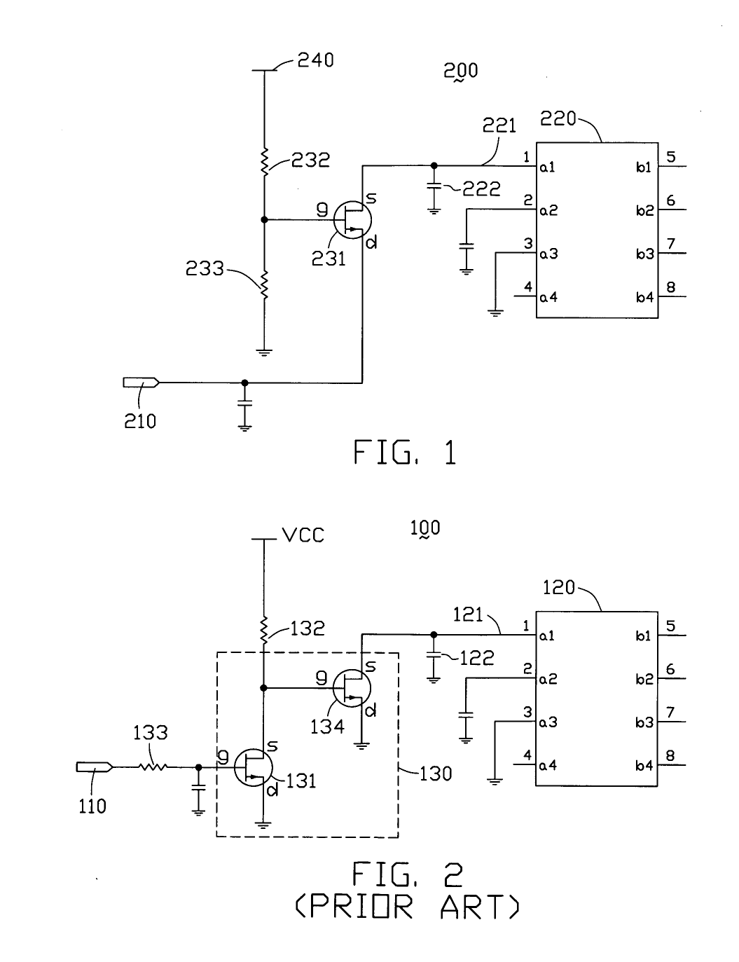

FIG. 1 is a circuit diagram of a backlight control circuit for use in an LCD according to a preferred embodiment of the present invention. The backlight control circuit 200 includes a signal input terminal 210, a capacitor 222, a PWM IC 220 for driving an inverter circuit (not shown), a transistor 231 for controlling the PWM IC 220, a first resistor 232, a second resistor 233, and an electrical source 240. The PWM IC 220 includes an enable pin 221, which is connected to ground via the capacitor 222. The transistor 231 includes a drain electrode “d” connected to the signal input terminal 210, a source electrode “s” connected to the enable pin 221 of the PWM IC 220, and a gate electrode “g” which is connected to the electrical source 240 via the first resistor 232 and which is connected to ground via the second resistor 233. The transistor 231 can be an NPN type transistor or a PNP type transistor. The electrical potential of the electrical source 240 is 5V. The resistance of the first resistor 232 is 10 KΩ. The resistance of the second resistor is 27 KΩ. Accordingly, the electrical potential at the gate electrode “g” of the transistor 231 is 3.6V. The configuration of the backlight control circuit 200 is simple, because the backlight control circuit 200 only has the one transistor 231.

Generally, operation of the backlight control circuit 200 is as follows. When the LCD is turned on by a user, a scaler IC (not shown) of the LCD generates an “ON” signal (3.3V), and supplies the “ON” signal to the signal input terminal 210. When the LCD is turned off by a user, the scaler IC (not shown) of the LCD generates an “OFF” signal (0V), and supplies the “OFF” signal to the signal input terminal 210.

When the “OFF” signal (0V) is applied to the signal input terminal 210, the drain electrode “d” of the transistor 231 is at 0V. Thus the voltage V_{gd} between the gate electrode “g” of the transistor 231 and the drain electrode “d” of the transistor 231 is 3.6V. Then the transistor 231 is turned on, and the enable pin 221 of the PWM IC 220 is discharged to 0V via the drain electrode “d” of the transistor 231. The PWM IC 220 stops working when the enable pin 221 thereof is a low voltage (0V). Then, the inverter circuit (not shown) which is driven by the PWM IC 220 is turned off. Thus the backlight (not shown) which is driven by the inverter circuit (not shown) is shut down.

When the “ON” signal (3.3V) is applied to the signal input terminal 210, the transistor 231 is turned off because that the voltage V_{gd} between the gate electrode “g” of the transistor 231 and the drain electrode “d” of the transistor 231 is 0.3V. Consequently, the enable pin 221 of the PWM IC 220 connected to ground via the capacitor 222 is charged to be at a high level voltage by an inner circuit (not shown) of the PWM IC 220. The PWM IC 220 starts to work when the enable pin 221 thereof is at the high level voltage. Then the PWM IC 220 turns on the inverter circuit (not shown), and the inverter circuit (not shown) drives the backlight to illuminate an LCD panel of the LCD.

In alternative embodiments, in order to realize the function of the backlight control circuit 200, the resistances of the first resistor 232 and the second resistor 233 can be adjusted on condition that a ratio of the resistance of the first resistor 232 to that of the second resistor 233 is in the range from 0.28 to 7.3. For example, when the resistance of the first resistor 232 is 10 KΩ, the resistance of the second resistor 233 is in the range from 1.8 KΩ to 35.4 KΩ.

It is to be understood, however, that even though numerous characteristics and advantages of preferred and exemplary embodiments have been set out in the foregoing description, together with details of the structures and functions of the embodiments, the disclosure is illustrative only; and that changes may be made in detail, especially in matters of shape, size, and arrangement of parts within the principles of present invention to the full extent indicated by the broad general meaning of the terms in which the appended claims are expressed.

What is claimed is:

1. A backlight control circuit comprising:
an electrical source;
a signal input terminal;
a pulse width modulation integated circuit (PWM IC) having an enable pin; and
a transistor comprising a drain electrode connected to the signal input terminal, a source electrode connected to the enable pin of the PWM IC, and a gate electrode connected to the electrical source via a first resistor and connected to ground via a second resistor.

2. The backlight control circuit as claimed in claim 1, further comprising a capacitor which is connected between the enable pin of the PWM IC and ground.

3. The backlight control circuit as claimed in claim 1, wherein the transistor is a positive-negative-positive type transistor.

4. The backlight control circuit as claimed in claim 1, wherein the transistor is a negative-positive-negative type transistor.

5. The backlight control circuit as claimed in claim 1, wherein the signal input terminal is configured to accept a controlling signal which is 0V or 3.3V.

6. The backlight control circuit as claimed in claim 5, wherein an electrical potential of the electrical source is 5V.

7. The backlight control circuit as claimed in claim 6, wherein a ratio of a resistance of the first resistor to that of the second resistor is in the range from 0.28 to 7.3.

8. The backlight control circuit as claimed in claim 7, wherein the resistance of the first resistor is 10 KΩ, and the resistance of the second resistor is in the range from 1.8 KΩ to 34.5 KΩ.

9. The backlight control circuit as claimed in claim 8, wherein the resistance of the first resistor is 10 KΩ, and the resistance of the second resistor is 27 KΩ.

10. A method of making backlight control circuit comprising:
providing an electrical source;
providing a signal input terminal;
providing a pulse width modulation integated circuit (PWM IC) having an enable pin; and
providing a transistor comprising a drain electrode connected to the signal input terminal, a source electrode connected to the enable pin of the PWM IC, and a gate electrode connected to the electrical source via a first resistor and connected to ground via a second resistor.
